(19) United States
(12) Patent Application Publication
(10) Pub. No.: US 2006/0116107 A1
(43) Pub. Date: Jun. 1, 2006

(54) System and method for pairing wireless headsets and headphones

(76) Inventor: Robert William Hulvey, Redondo Beach, CA (US)

Correspondence Address: CHRISTIE, PARKER & HALE, LLP, PO BOX 7068, PASADENA, CA, 91109-7068, US

(21) Appl. No.: 11/286,066

(22) Filed: Nov. 22, 2005

Related U.S. Application Data
(60) Provisional application No. 60/630,635, filed on Nov. 24, 2004.

(51) Int. Cl. H04M 1/68

(52) U.S. Cl. 455/411; 713/168; 713/150; 455/569.1

(57) ABSTRACT

A wireless headset including a CPU for generating a random number; a speaker; and a voice synthesis circuit for announcing the generated random number via the speaker, wherein the announced number is input to a host device as a PIN to establish a secure wireless communication link between the host device and the headset. In one embodiment the wireless headset includes a first operational button for selecting alphanumeric characters; and a second operational button for confirming the selected alphanumeric characters for input to the headset. In one embodiment the headset includes a microphone for accepting a spoken PIN as an input; speech recognition means for recognizing the spoken PIN; and speech synthesis means for announcing the recognized PIN via the speaker.

### CROSS-REFERENCE TO RELATED APPLICATION

This Patent Application claims the benefit of the filing date of U.S. Provisional Patent Application Ser. No. 60/630,635, filed on Nov. 24, 2004 and entitled “SYSTEM AND METHOD FOR PAIRING WIRELESS HEADSETS AND HEADPHONES,” the entire content of which is hereby expressly incorporated by reference.

### FIELD OF THE INVENTION

The present invention relates generally to wireless devices; and more particularly to establishing a communication link between wireless headset or headphone devices and an audio source device.

### BACKGROUND OF THE INVENTION

Wireless communication is rapidly growing. For example, audio peripheral devices such as headsets and headphones are increasingly utilizing wireless communication to communicate with a host device, such as a PC, a mobile phone, music player, or any other related device. Bluetooth (BT) is a wireless protocol that is being used extensively for communication in such systems. In order to protect the user against eavesdropping or to prevent copying of copyrighted material, it is desirable to establish an encrypted link between the headphone or headset and the host device. BT security depends on establishing a shared secret (called a link key) between two BT devices/systems. The BT protocol uses the link key for authentication and encryption. The BT link key is typically established via a BT “pairing” process defined in the BT specification. This process involves setting up a BT connection between two BT devices/systems, entering an identical personal identification number (PIN) code on both sides, and using the PIN code to derive a shared secret link key.

In addition, BT devices/systems can remember the BT address and link keys of other BT devices/systems with which they have been connected before and use this information to quickly recreate a secure connection. The process by which BT devices/systems discover other BT devices/systems, connect to them, establish a link key and then store the Bluetooth device (BD) address and link key for future use, is referred to in the following discussion as the BT “bonding” process. A description of this process is part of the BT specification.

BT headset and headphone devices suffer from an insecure pairing scheme. Since headsets and headphones generally have a very limited user interface, most Bluetooth headsets and headphones currently on the market use fixed PIN codes. For example, a PIN of “0000” is typical on multiple brands of headphones. When pairing with a PC or phone, the user would then enter “0000” as the PIN on the user interface of the PC/phone. Fixed PINs are often listed in users' manuals and easy for an intruder/attacker to find. The use of a fixed PIN significantly lowers the security of the link, since an eavesdropper can use the knowledge of the PIN to decipher wireless traffic “sniffed” over the air as the headset connects to other wireless devices. The attacker with knowledge of the fixed PIN can also can decrypt traffic between a headset or headphone device and its host, and even assume the identity of the headset/headphone device (also known as impersonation).

Therefore, there is a need for a method and system to improve the security of wireless headset and headphone devices.

### SUMMARY OF THE INVENTION

The present invention provides an improved method and system for establishing wireless communication between two BT devices.

In one embodiment the present invention is a wireless headset comprising: a CPU; a random number generator for generating a random number; a speaker; and a voice synthesis circuit for announcing the generated random number via the speaker, wherein the announced number is input by the user into a host device as a PIN to establish a secure wireless communication link between the host device and the headset. The host may optionally download voice synthesis data for numbers or characters into the headset, for example, in the preferred language selected by the user on the host, thereby eliminating the need to store such voice synthesis data on the headset.

In one embodiment the present invention is a wireless headset comprising: a first operational button for selecting alphanumeric characters; and a second operational button for confirming the selected alphanumeric characters for input to the headset, wherein the alphanumeric characters input to the headset produce a PIN for establishing a wireless communication link between the host and the headset device, and the PIN used may be entered by the user or randomly generated on the host device. Optionally, selecting characters may be done using more than one button, or by a volume or scroll wheel (sometimes called a “jog” wheel) if available on the headset.

In one embodiment the present invention is a wireless headset comprising: a microphone for accepting a spoken PIN as input; speech recognition means for recognizing the spoken PIN; a speaker; and optional speech synthesis means for announcing the recognized PIN via the speaker, wherein the recognized PIN is input to a host device to establish a wireless communication link between the host device and the headset.

In one embodiment the present invention is a method for establishing secure wireless communication between a host and a headset device, the headset device including a speaker. The method includes generating a random number by the headset device; announcing the generated random number via the speaker; inputting the announced number to the host via a user interface; and establishing a wireless communication link between the host and the headset device utilizing the random number as a PIN.

In one embodiment, a public/private key pair is exchanged between the headset and the host to encrypt the information transmitted over the wireless communication link, and the PIN is used to authenticate the headset and/or the host.

In one embodiment, the wireless communication is Bluetooth wireless communication. One skilled in the art will recognize that the invention described herein may also be applied to systems incorporating other standard wireless protocols such as Zigbee, WiFi, 802.15, as well as to proprietary wireless communication protocols.

### BRIEF DESCRIPTION OF THE DRAWINGS

FIG. 1 is an exemplary block diagram of a system for a wireless connection of a headset device;

FIG. 2 depicts a headset modified according to one embodiment of the present invention;

FIG. 3 illustrates an architecture of Bluetooth wireless communication protocol;

FIG. 4 depicts example profiles of Bluetooth protocol stacks for executing a pairing process, according to one embodiment of the present invention; and

FIG. 5 is an exemplary sequence diagram for Bluetooth operation under stack control, according to one embodiment of the present invention.

### DETAILED DESCRIPTION

In one embodiment, the present invention is a method and system for pairing of a wireless headset and/or headphone device with a host PC and/or a mobile phone. A headset is typically a device supporting monaural speech input and output used for telephone calls. A pair of headphones is typically a device with two speakers which supports playback of high fidelity audio such as music. Some devices support both bi-directional monaural speech as well as high-fidelity music playback, and these hybrid devices are sometimes called “ultimate headsets.” For simplicity, all such devices are hereinafter referred to as headsets collectively for simplicity.

A request for pairing is generated by the host device which wirelessly finds and then connects to the headset. The headset then randomly generates a PIN and derives from the PIN a link key (e.g., by using the received PIN from the headset) and stores the link key and the BD address of the host device.

The host device receives the BD address for the headset and derives the link key using the PIN entered by the user and stores the link key locally. The two devices can then authenticate each other over the wireless link using the shared link key.

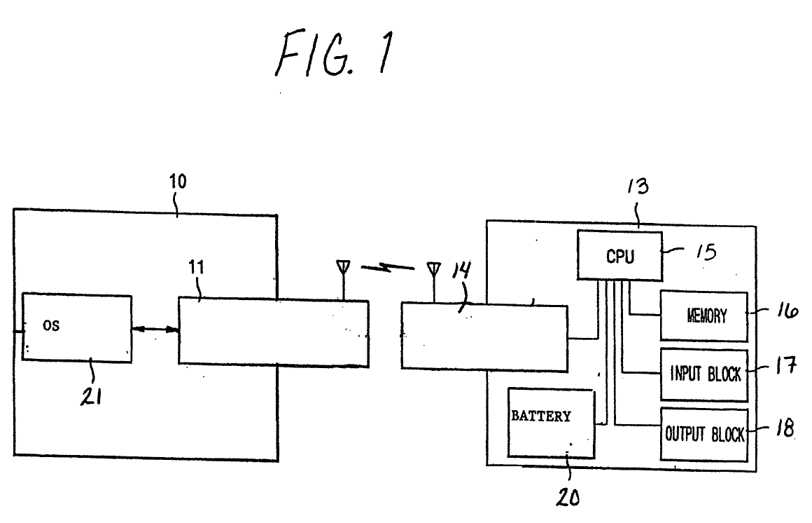

In one embodiment, the wireless link is a Bluetooth protocol. FIG. 1 is a block diagram of a system for establishing a communication link to a headset or headphone device 13. A PC 10 includes a wireless communication interface 11, for example a Bluetooth (BT) communication interface, for transmitting and receiving data between PC 10 and the headset device 13. PC 10 also includes an operating system (OS) 21. In one embodiment, wireless communication interface 11 is a BT transceiver that plugs into PC 10 and thus making PC 10 Bluetooth capable.

Headset device 13 also includes a wireless communication interface 14 for receiving and transmitting data from/to PC 10. Headset device 13 may also include a CPU 15, a memory 16, an input block 17, and an output block 18. Memory 16 may include a ROM for storing instruction executed by the CPU, a RAM for storing information, and a non-volatile memory for storing link key, BD addresses, and the like. Headset device 13 also includes a battery 20 that is preferably re-chargeable. Wireless communication interface 14 is coupled to CPU 15 and transmits data to OS 21 for execution on PC 10. The input block 17 of the headset typically includes one or more buttons and may also include one or more microphones. The output block 18 of the headset typically includes one or more speakers and possibly also LED indicator lights.

In one embodiment, PC 10 and device 13 use Bluetooth protocol to wirelessly communicate with each other, after the pairing is accomplished. To establish a Bluetooth wireless communication link, a first radio transceiver (for example, BT interface 14) associated with the PC 10, and a second radio transceiver (for example, BT interface 11) associated with device 13 are configured to automatically find and contact each other to establish a wireless communication link upon being brought into proximity with each other and each being activated by the user. Typically, host systems utilizing the Bluetooth communication protocol transmit a general inquiry (or in some cases, a limited inquiry), which is received and acknowledged by devices located within receiving range which are configured for general or limited discoverable mode, as defined in the Bluetooth specification. Once a second Bluetooth configured device is identified, a link is established and optionally authenticated.

Establishing a Bluetooth link authentication requires the initiating Bluetooth system to check to see if a link between the two communicating devices has already been previously established. If a link has been previously established, the authentication is automatically accepted by the initiating Bluetooth device. Upon the first time that two devices communicate, or if the authentication using an existing link-key fails between two devices, an initialization procedure is needed to create a common link key in a safe manner. This initialization procedure is called pairing. The method and system of the present invention utilizes various user interface (UI) means and methods to accomplish a secure and efficient pairing of a headset (or a headphone) and a PC (or a phone). Once the pairing is accomplished, the two devices are initialized and ready to wirelessly communicate with each other.

Typically, an authentication procedure first checks to see if a link between the two devices has been already authenticated. If so, the authentication is confirmed. If the link between the two devices is not currently authenticated but a common link key exists between the two devices (from a previous link), the authentication procedure may re-authenticate the link. If the authentication fails, or if there are no common link keys available between the two devices, the authentication procedure initiates the pairing procedure to generate a new set of link keys between the two devices. Successful completion of the pairing procedure results in the establishment of a valid link-key between the two devices. A complete description of the Bluetooth authentication procedures may be found in the “Specification of the Bluetooth System,” Version 1.2, published Nov. 5, 2003, the relevant contents of which are hereby expressly incorporated by reference.

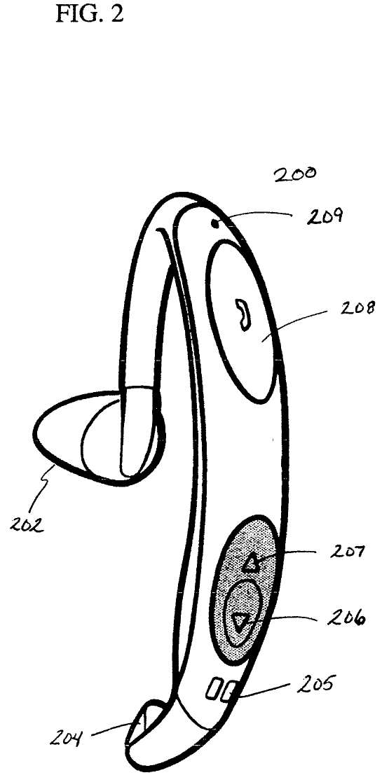

FIG. 2 is a wireless headset 200 configured according to the present invention. The wireless headset includes a speaker 202, a microphone 204, an external port 205 which may be used for charging the battery, volume down control button 206, volume up control button 207, a multi-function button 208 that control various functions, and one or more LEDs 209. Typically, a conventional wireless headset also includes all or most of the above-mentioned components of the headset shown in FIG. 2. However, in one embodiment, the headset of the present invention is further configured to utilizes these existing buttons and features of a conventional headset to generate a unique PIN for establishing a secure wireless connection with a host device, such as a PC or phone. In this embodiment, the PIN may be entered by the user on the host device, or may be randomly generated on the host and displayed to the user.

In one embodiment, for a first-time connection, the headset generates (for example, via the CPU 15) a random PIN to be used for pairing with the host PC or phone. This PIN is then “announced” through the speaker 202 of the headset, using speech synthesis techniques embodied in the headset 200 and/or programmed in the CPU 15. The user may then enter this PIN into the host device (using an input device, such as a keyboard) to which the headset 200 is being paired. The generated PIN is unique to the headset because it was randomly generated and the host device now knows the unique PIN to generate the link key and initiate the pairing process using the unique PIN. This way, the pairing process is substantially more secure and less prune to attacks.

In one embodiment, a unique (numeric or alphanumeric) PIN may be spoken into the microphone 204 of headset 200 by the user, during the pairing process. In this embodiment, headset 200 includes speech recognition capabilities, for example, speech recognition software and/or firmware to recognize the spoken numeric or alphanumeric PIN. Speech recognition software and/or firmware are well known in the art and simplified versions are well suited for this embodiment of the present invention.

Speech synthesis can optionally be used as a feedback to the user to verify that the PIN was recognized by the headset correctly. The user then enters the PIN in the host device (using an input device, such as a keyboard) to which the headset/headphone is being paired, that is, a PC or phone. In this embodiment, with addition of some (relatively basic) speech recognition capabilities (preferably, via software and/or firmware), the headset is enabled to accept unique PINs from the user, resulting in enhanced security.

In one embodiment, the user may use existing buttons on the headset 200 to enter a PIN. Optionally, the embodiment may include synthesized speech to provide feedback of the entered PIN. For example, the volume up/down switches 207 and 206 may be used to select a digit (or character), while the multi-function button 208 may be used to confirm the currently selected digit/character and move on to the entry of the next digit/character until some pre-determined length for the PIN is reached. Headset 200 includes software to recognize the activation of these buttons as alphanumeric characters. The user then enters the same alphanumeric PIN into the host device (using an input device, such as a keyboard) to which the headset 200 is being paired. Optionally, the host device may generate a random alphanumeric PIN and display or announce this to the user such that the user may enter the PIN on the headset 200 using the available buttons.

In one embodiment, the present invention is further enhanced by use of public-private key encryption. A link-key may be generated between the host device and the headset device utilizing public-private key techniques which are well known in the art. The link-key thus created can then be authenticated using an appropriate authentication algorithm. Such an authentication algorithm may involve entering a PIN on either end of the link, or alternately may simply involve having the user compare a checksum or hash of the shared link-key. In either case, the PIN or hash may be announced to the user on the headset using voice synthesis. The public/private key exchange process does not require the link-key to be a function of the PIN as in the current BT specification, thereby increasing the security of the wireless link. Several such authentication approaches have been proposed for improving Bluetooth security within the Bluetooth Special Interest Group (SIG) which creates the Bluetooth specification, as well as in academia.

For example, current Bluetooth standards require that the PIN be used directly in the creation of the link key that is used to authenticate and encrypt the link between the two devices. Since users tend to use short PINs for simplicity, dictionary attacks can be easily mounted. Using the PIN only for certifying both ends of the link eliminates a man-in-the-middle type of attack. This public/private key exchange approach to negotiating the link key would then discard the PIN, once the link pairing has been established.

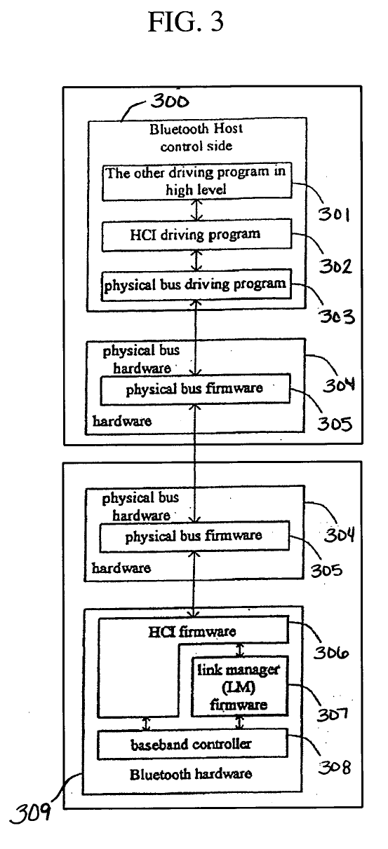

FIG. 3 illustrates an architecture of Bluetooth wireless communication protocol. A physical bus hardware 304 connects the Bluetooth host 300 and the Bluetooth hardware 309. The structure of the Bluetooth hardware 309 includes a baseband controller 308, a host controller interface (HCI) firmware 306, and a link manager (LM) firmware 307. During the wireless transmission, the host controller interface firmware 306 encodes the received data into a format of HCI packet, and the HCI packet is further fed into the Bluetooth host 300 via a physical bus firmware 305. Different functions can be performed under the Bluetooth system, after the HCI packet has been sequentially processed by a physical bus driving program 303, the HCI driving program 302 and other driving program 301.

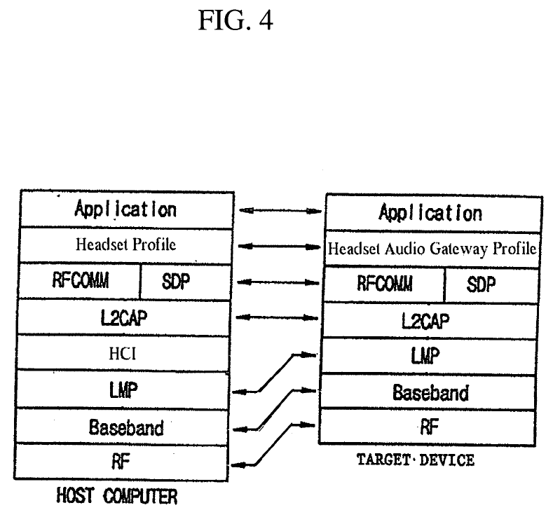

FIG. 4 depicts example profiles of Bluetooth protocol stacks for executing the pairing process between two wireless devices, according to one embodiment of the present invention. Bluetooth protocol stacks such as the HCI, the L2CAP and the RFCOMM and the profiles may respectively be realized inside the device drivers, the kernel, the BIOS, and the like of the PC 10 as well as, the application program, and the like of the headset 13.

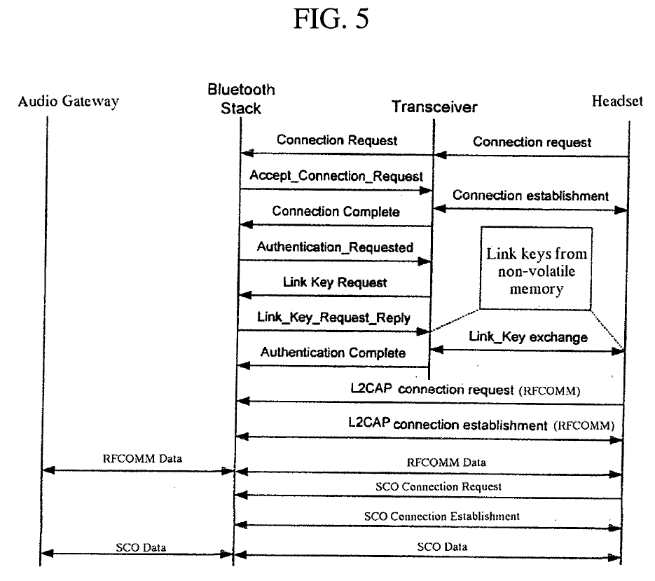

FIG. 5 is an exemplary sequence diagram for Bluetooth operation under stack control, according to one embodiment of the present invention. As shown, when the headset (HD) is not connected via the wired interface and the user attempts to use it (for example, presses a button), the headset pages the host using the BD address of the host. The host accepts the connection and proceeds with authenticating the headset using the link key, as described above. The headset then sets up the headset control and interrupt channels and begins providing headset reports to the host via the BT link. If encryption is used, BT protocol derives an encryption key from the link key, and uses the encryption key to encrypt the information transmitted over the air.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method for establishing secure wireless communication between a host and a headset device, the headset device including a speaker, the method comprising:
generating a random number by the headset device;
announcing the generated random number via the speaker;
inputting the announced number to the host via a user interface; and
establishing a wireless communication link between the host and the headset device utilizing the random number as a link key.

2. The method of claim 1, wherein the wireless communication is Bluetooth wireless communication.

3. The method of claim 1, further comprising exchanging a public/private key pair between the headset and the host; and utilizing the public/private key pair to encrypt the information transmitted over the wireless communication link.

4. The method of claim 1, wherein the random number is one or more of the group a hash of the link-key, and a cryptographically authenticated key.

5. A wireless headset comprising:
a CPU;
means for generating a random number;
a speaker; and
a voice synthesis circuit for announcing the generated random number via the speaker, wherein the announced number is input to a host device as a PIN to establish a secure wireless communication link between the host device and the headset.

6. The wireless headset of claim 5, wherein the wireless communication is Bluetooth wireless communication.

7. The wireless headset of claim 5, further comprising means for exchanging a key between the headset and the host to encrypt the information transmitted over the wireless communication link.

8. The wireless headset of claim 7, wherein the key is one or more of the group a public/private key pair, a hash of a link-key, and a cryptographically authenticated key.

9. A method for establishing secure wireless communication between a host and a headset device, the headset device including plurality of operational buttons, the method comprising:
selecting an alphanumeric character, using a first one of the plurality of operational buttons of the headset device;
confirming the selected alphanumeric character for input to the headset device, using a second one of the plurality of operational buttons of the headset device;
repeating the selecting and the confirming steps until a PIN with a desired length is input to the headset device;
inputting the input PIN with the desired length to the host via a user interface; and
establishing a wireless communication link between the host and the headset device utilizing the input PIN.

10. The method of claim 9, wherein the wireless communication is Bluetooth wireless communication.

11. The method of claim 9, further comprising announcing the PIN after it is input to the headset device, via a speaker of the headset device.

12. The method of claim 9, further comprising exchanging a key between the headset and the host; and utilizing the public/private key pair to encrypt the information transmitted over the wireless communication link.

13. The method of claim 12, wherein the key is one or more of the group a public/private key pair, a hash of a link-key, and a cryptographically authenticated key.

14. A wireless headset comprising:
a first operational button for selecting alphanumeric characters; and
a second operational button for confirming the selected alphanumeric characters for input to the headset, wherein the alphanumeric characters input to the headset produce a PIN for establishing a wireless communication link between the host and the headset device.

15. The wireless headset of claim 14, wherein the wireless communication is Bluetooth wireless communication.

16. The wireless headset of claim 14, wherein the first operational button is a scroll wheel.

17. The wireless headset of claim 14, wherein the second operational button is a scroll wheel.

18. The wireless headset of claim 14, further comprising means for exchanging a public/private key pair between the headset and the host to encrypt the information transmitted over the wireless communication link.

19. The wireless headset of claim 14, further comprising speech synthesis circuit for announcing the PIN after it is input to the headset, via a speaker of the headset.

20. A method for establishing secure wireless communication between a host and a headset device, the headset device including a speaker and a microphone, the method comprising:
outputting a randomly generated PIN from the host to the user;
speaking a PIN into the microphone;
recognizing the spoken PIN by the headset device; and
establishing a wireless communication link between the host and the headset device utilizing the PIN.

21. The method of claim 20, further comprising the step of announcing the recognized PIN, via the speaker.

22. The method of claim 20, wherein the wireless communication is Bluetooth wireless communication.

23. The method of claim 20, further comprising exchanging a key between the headset and the host; and utilizing the public/private key pair to encrypt the information transmitted over the wireless communication link.

24. The method of claim 23, wherein the key is one or more of the group a public/private key pair, a hash of a link-key, and a cryptographically authenticated key.

25. A wireless headset comprising:
a microphone for accepting a spoken PIN as an input;
speech recognition means for recognizing the spoken PIN;
a speaker; and
speech synthesis means for announcing the recognized PIN via the speaker, wherein the announced PIN is output from a host device and used to establish a wireless communication link between the host device and the headset.

26. The wireless headset of claim 25, wherein the wireless communication is Bluetooth wireless communication.

27. The wireless headset of claim 25, further comprising means for exchanging a public/private key pair between the headset and the host to encrypt the information transmitted over the wireless communication link.
